(19) United States
(12) Patent Application Publication
(10) Pub. No.: US 2006/0073964 A1
(43) Pub. Date: Apr. 6, 2006

(54) Preparation of catalyst for direct decomposition of nitrogen oxide

(76) Inventors: Rueih-Yuh Weng, Miao-Li Hsien (TW); Kuo-Tien Hsieh, Miao-Li Hsien (TW); Ya-Wei Yang, Miao-Li Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/949,310

(22) Filed: Sep. 27, 2004

(51) Int. Cl. B01J 29/06

(52) U.S. Cl. 502/66

(57) ABSTRACT

The present invention refers to a kind of deNOx catalyst without the reducing agent to decompose the NO, wherein it is to mix the Zeolite with Al2O3, then they were dried, calcined, and powdered to make the catalyst carrier, after adding the Pt/Rh or Pd/Rh noble metal solutions, again dry and calcine, then the deNOx catalyst without the usage of reducing agent such as ammonia, propane could be thus obtained, wherein its optimum conversion of stripping deNOx is within 250-500° C., besides, at the condition that there is CO except NO for that polluted air, the rate of stripping for the present invention could also achieves a fine results. Please discloses the formula which best represents the present invention if there is any: 2NO←→N2+O2

### FIELD OF THE INVENTION

The present invention relates to a kind of deNOx catalyst without the reducing agent to decompose the NO, which is a catalyst that achieves the purpose of get rid of the NOx pollutant in the air without the usage of reducing agent.

### BACKGROUND OF THE INVENTION

The conventional NO decomposition catalyst is to utilize the selective catalytic reduction, SCR, which emphasis there requires the reducing agent to be transformed with the catalyst for NO, while the basic principle of the conventional selective catalyst reducing method is by utilizing the NH3 or urea as the reducing agent, which inject into the system with a certain proportion that mixed completely with the flue gas being deal with, under sufficient oxygen (at least 2%), after catalytic reaction by the catalysts, which reduces NOx into N2 and H2O.

The selective catalyst reduction method, though it has the advantage of high efficiency of nitrogen stripping, also has the following problems: since NH3 is the gas that is to be managed for the environmental protection and industrial safety unit, if it reacts with the catalyst incompletely, it is easily to cause secondary air pollution, with the smell, as well as the drawback of bulk volume of required equipments.

In recent years, many other reducing agent are proposed to replace NH3 as the reducing agent, in the selective catalyst reduction process, which also better the catalyst toward many aspects to elevate the efficiency of nitrogen stripping reaction.

Tanabe et al. pointed out that when the addition of the Zeolite in the selective catalyst reducing catalyst and using HC as the reducing agent, the hydrocarbon (HC) is absorbed on the zeolite, which is benefit to the NO reducing efficiency under the elevated temperature ambient environments. The catalyst composition they utilized compromised Pt, Zeolite, CeO2-ZrO2 as well as thermal stability oxide such as SiO2; during the reaction process, hydrocarbon will absorbed into the zeolite under low temperature; while hydrocarbon began to migrate onto the surface of Pt to proceed the reaction of reducing NOx; the oxygen released from the CeO2-ZrO2 could inhibit the toxicity reaction of the hydrocarbon under low temperature conditions, which promotes the reduction reaction of NOx; for such application of said idea, please refer to mentioned by the U.S. Pat. No. 4,297,328, No. 5,001,098, No. 5,041,270, No. 5,206,196, No. 5,208,198, No. 5,382,416, No. 5,407,651, No. 5,433,933, No. 5,985,225, No. 6,087,295, No. 6,191,061.

Anunziata et al utilizes the zeolite H-ZSM5 containing Fe3+ as well as Fe2+ to proceed the deNox related experiments, and found when the content of Fe2+ is 3 wt %, the rate of stripping of NOx under 350° C. reaction temperature is 70%, if he uses the zeolite with the same contents of Fe3+ to proceed refine, there is strangely no condition of elevating the rate of stripping the NOx happened. They suspects that the main reason is among the zeolite refined by Fe2+, the Lewis site is far more than that in the zeolite refined by Fe3+, which leads the zeolite refined by the Fe2+ could thus elevate the reducing efficiency of NOx; please refer to what is mentioned in the U.S. Pat. No. 6,033,641 for such kinds of application of the idea.

Kooten et al. investigates the water heated de-activation reaction of the deNOx catalyst to add the Ce3+ into different kinds of zeolite, wherein the used zeolite comprises ZSM-5(MFI), Beta, Mordenite and Y type, X of which he selects ZSM-5 with three various Si/Al proportions to proceed his experiment. Under 600° C. through 50 hours aging, X the activity of three Ce-ZSM-5 catalyst all loses 80%, so the factor that the proportion of Si/Al influences the deactivation process is excluded; besides, he also points out that Ce-Beta and Ce-Yare two catalysts with relatively degree of stability, especially Ce-Beta is aging for 99 hours at 600° C. and 10% H2Oenvironments, the deNOx reactive procedure which utilizes NH3 as the reducing agent, when the temperature is at 450° C., the conversion of NOx is 80%; please refer to what is mentioned at U.S. Pat. No. 5,681,788 for the application of such ideas.

Ismagival et al. compares the Ce, TiO2 refined Cu-ZSM-5 catalyst vs. unrefined catalyst toward water resistance and sulfide, wherein the operational condition of removing the NOx utilizing propane as the reducing agent, the ranges of reactive temperature is within 200-600° C., the results finds that the refined catalyst, when placing at the environment containing sulfide and water molecules, with the 400° C. and 500° C., there is no obviously decrease for the conversion of NOx, which means that said catalyst bears fine property of anti-sulfide and water interference-resistance; please refer to U.S. Pat. Nos. 5,343,702, 5,993,764, 6,548,725 mentioned.

Besides, among the aspect of the fabrication method of catalyst, please refer to patent U.S. Pat. No. 342,354 “Pd alloy catalyst of thermal decompose de-nitrogen”, which is to prepare the Pd with the noble metal with suitable proportions to make the alloy, next to form the Pd alloy catalyst on the high-temperature bearing catalyst carrier of Al2O3 or MgAl2O4 with conventional impregnation method, wherein the content of Pd is within 0.05%-2%; the ratio of the alloy is selected from Pd—Cu 10-1; Pd—Ag 20-1; Pd—Au 40-10.

### SUMMARY OF THE INVENTION

The inventor of the present invention, in order to elevate the rate of stripping the NOx in the air as well as to develop the low-cost deNOx catalyst which achieves efficient rate of turnover without the reducing agent, so they invent the present invention which conforms to the above-mentioned conditions that is a direct decomposition of NO without a reducing agent.

The main object of the present invention is to provide a deNOx catalyst without the reducing agent to decompose NOx, which is to mix the zeolite with Al2O3, next to add noble metal solutions of Pt/Rh or Pd/Rh, then a nitrogen stripping catalyst without the usage need of the reducing agents such as propane is thus produced, also there is a certain conversion under the condition of containing CO in the polluted air.

### BRIEF DESCRIPTION OF THE DRAWINGS

FIG. 1: is the comparison figure of the various kinds of the temperature of the catalyst vs. NO conversion of the present invention.

FIG. 2: is the comparison figure of the FER catalyst of the present invention the temperature vs. Various reducing agent concentrations vs. NO conversion.

FIG. 3: is the comparison figure of the FER catalyst of the present invention the oxygen concentration vs. Various reducing agent concentrations vs. NO conversion.

FIG. 4: is the process flowchart of the catalyst preparation of the present invention.

FIG. 5:is the process flowchart of the mixing operation of the present invention.

FIG. 6: is the process flowchart of the impregnation operation of the present invention.

FIG. 7: is the process flowchart of the ball-mill operation of the present invention.

### DETAILED DESCRIPTION OF THE PREFERRED EMBODIMENT

In order to make the committee more understanding the structure, character as well as other object of the present invention, it is illustrated with the preferred embodiment in accompanying with the drawings; however, it does not mean to confine the scope of the present invention.

The deNOx catalyst (A) uses Al2O3 and zeolite as the carrier, which also adds Pt/Rh or Pd/Rh as its composition.

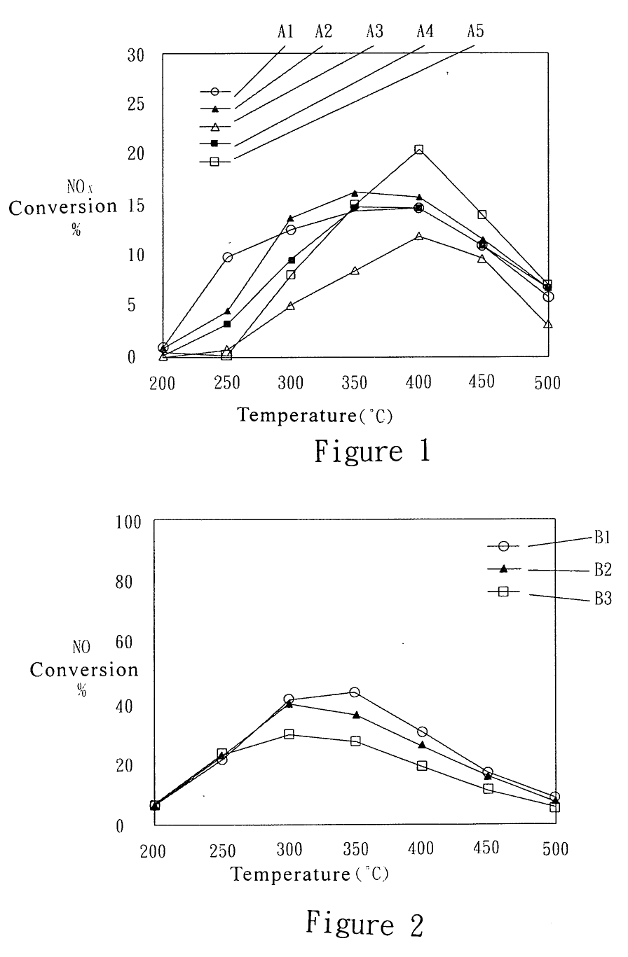

First, we treats the present invention as the main body, in cooperative with various kinds of zeolite (C) to form the catalyst (A) to test the conversion of NOx to proceed research and experiment, wherein the experiment condition is: there purges C3H8 (B) inside the reaction tube as the reducing agent, and its concentration is controlled within 1000-1200 ppm, in cooperative with the initial concentration of NO 700-720 ppm, the O2 amount inside the reactive system is 5%-5.2%, the reaction temperature is 200-500° C., also the space velocity (SV) is 60000 hr-1, wherein the results of experiments please see FIG. 1 for illustration, it is, seen that FER catalyst (A5), when at 400° C., its conversion of NO is 20% at its optimum, next is MOR catalyst (A2), its conversion of NO at 350° C. is about 16%, the third isβzeolite catalyst (BEA) (A4), the conversion of NO at 350˜400° C. is maintained at 15%. Whereas FAU catalyst is also maintained at 15% at 400° C. As for MFI zeolite, it is maintained at 12% at 400° C.

The same as the above results, which makes further study toward the deNOx reaction of the reducing agent concentration aiming at the optimum FER catalyst (A5), it is settled under the experiment conditions that the spec of the ceramics monomer is ψ2*2 cm, 400 cel, the space velocity (SV) is 60000 hr-1, the carrier gas is N2, with or without propane (C3H8) (B) as the reducing agent, the results of experiments please refer to FIG. 2, when the concentration of propane (C3H8) is 0 ppm (B1), the NO conversion at 350° C. is as high as 50%, when the concentration of propane (C3H8) is about 500 ppm, the NO conversion at 300° C. reaches 40%, whereas when the concentration of propane (C3H8) is 1000 ppm, the NO conversion at 300° C. also reaches 30, so it could be referred that the NO conversion of the catalyst (A) decreases as the increase of the concentration of the reducing agent of propane (C3H8) (B), which is in variance with the reaction mechanism on the past literature report.

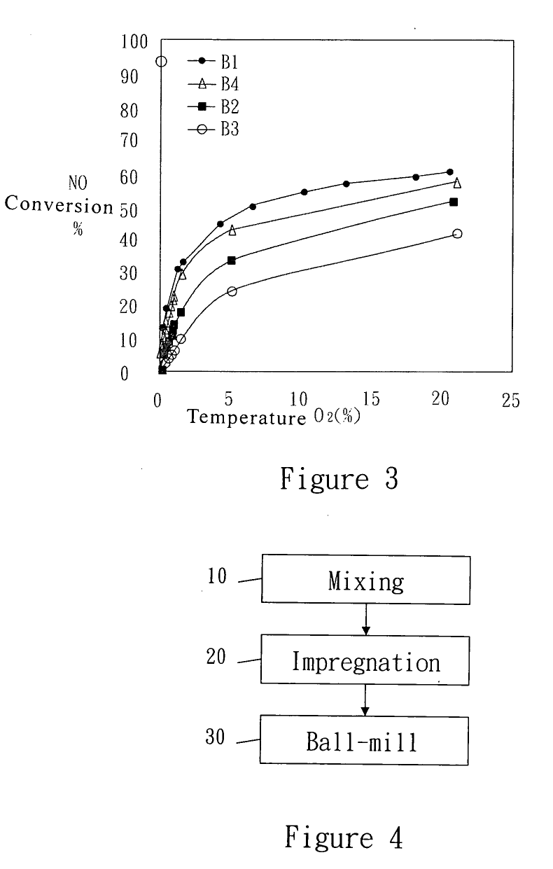

The effect of oxygen is also showed in FIG. 3. The experiments are carried out: by using FER catalyst (A5), initial concentration of NO is 700 ppm, the space velocity is 60000 hr-1, the reaction is carried out at temperature of 350° C.

The results of experiments, please refer to FIG. 3, which shows that in absence of oxygen and various propane (B) concentrations, NO conversion is as high as 90%; when the propane concentration is 100 ppm (B4) and propane concentration is 500 ppm (B2) under the oxygen concentration increasing to 0.1%, the NO conversion decreases sharply, whereby it elevates gradually as the oxygen concentration increases. When the oxygen concentration reaches 20%, NO conversion elevates relatively to 50-55%. When there is no propane introduced (B1), the NO conversion could reach as high as 60%, Whereby at the propane concentration of 1000 ppm (B3) , the oxygen concentration requires to increase to 0.3%, then the lowest NO conversion has been discovered. Then the reaction trend is the same as the above-mentioned.

In sum up, the present invention utilizes aluminum oxide (C) in conjugation with five different zeolite (D) to be the carrier and adds the catalyst (A) composted by (Pt/Rh) or (Pd/Rh), at 250˜500° C. under no reducing agent conditions, it has a preferred deNOx conversion,

Besides, from the experiments it is known that it is also good for using Pd/Rh components.

Besides, related to the preparation process of the catalyst (A) of the present invention, please refer to FIG. 4, which is to execute the mixing (10) first, next to execute the impregnation (20) as well as ball-mill (30), and the preparation operation of catalyst (A) is thus completed.

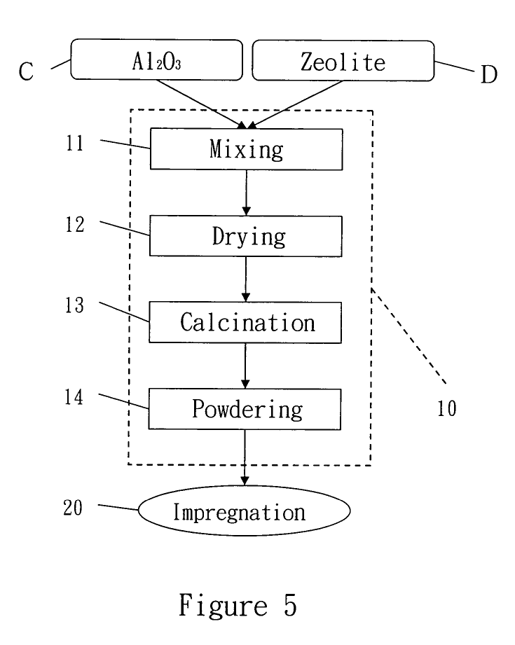

Please see as shown in FIG. 5, wherein the mixing (10) comprises:
Mixing (11): to mix the aluminum oxide (C) with the zeolite (D), the zeolite used herein is FER typed, and SiO2/AlO2 ratio is equal to 55;
Drying (12): to dry the mixed materials;
Calcination (13): to high-temperature form the catalyst carrier for the dried mixing materials;

Powdering: to powder the formed mixed materials for the benefit of the next stage's impregnation (20).

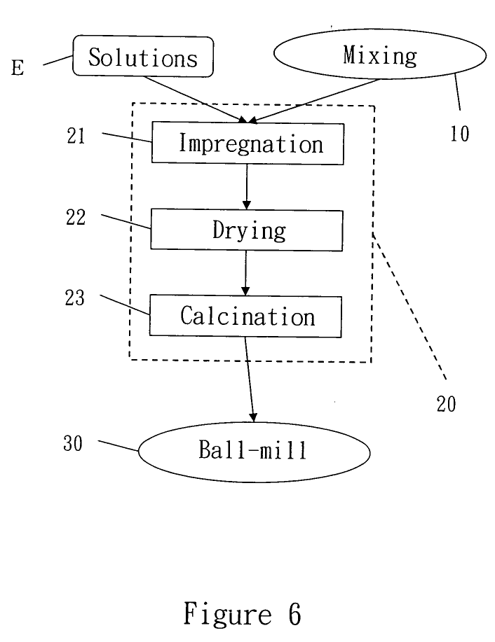

Please see what is illustrated in FIG. 6, wherein the impregnation (20) comprises:

impregnation (21): mix the powder typed aluminum oxide (C) and zeolite (D) with homologous into the catalyst carrier, which impregnation into Pt/Rh noble solutions (E);

Drying (22): to dry the immersed half-works;

Calaination (23): to form it at high temperature for the impregnated half-works after drying for the benefit of next-stage ball-mill operation.

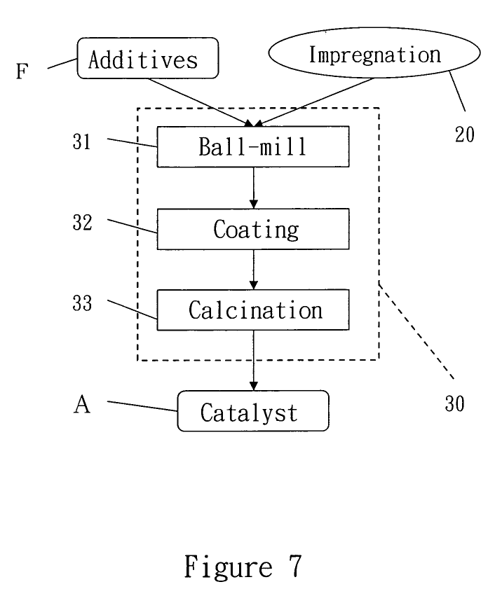

Please refer to FIG. 7, wherein the ball-mill operation (30) comprises:

Ball-mill (31): which is to add the additives (F) into the dried Aluminum oxide (C), zeolite (D as well as the ball-mill half works of Pt/Rh noble metal solutions (E) and next to powder it, said additives (F) could be aluminum oxide (AlO2)(C), PVAC, nitric acid (HNO3) or water (H2O) etc;

Coating (32): the powder typed ball grid half works onto the ψ2*2 cm, 400 cel cement carriers;

Calcination (33): high-temperature calcination the above-mentioned cement carrier which completed Coating (32), then the catalyst (A) without reducing agent comprising Zeolite ( D ), aluminum oxide(Al2O3)(C) Pt/Rh, which is also FER catalyst(A5),

Besides, the zeolite (D) used also could use FAU typed zeolite of which SiO2/AlO2 ratio is equal to 60, then FAU typed catalyst (A1) could be prepared through such process.

Besides, the zeolite (D) used could also be MOR styled, and its SiO2/AlO2 ratio being equal to 90, then the MOR catalyst (A2) could be prepared through such process.

Besides, the zeolite (D) used could choose MFI style, wherein its SiO2/AlO2 is equal to 80, then the MFI catalyst (A3) could be prepared through such process.

Besides, the zeolite used could also BEA catalyst style, wherein its SiO2/AlO2 is equal to 75, then the BEA catalyst (A4) could be prepared through such process.

Besides, noble metal solution (E) could also use Pd/Rh, thus, the present invention could achieve the below-mentioned object of betterment:
1. elevate the degree of safety largely: since there is no need to use the reducing agent such as ammonia, propane(B), wherein ammonia is a kind of industry safety gas and propane is combustible, so the present catalyst (A) could elevate the degree of safety largely.
2. Decrease the second pollution caused by the incomplete mixing: since it utilizes propane (B) to precede NO decomposition, it is possible to cause poor rate of decomposition reaction due to incomplete mixing which makes NO2 and thus cause the second pollution of the environments.
3. relatively low cost of investment: since it is needless to prepare the storage device and the reaction means due to the character of the reducing agent, which could lower the cost of investment largely, and the present catalyst (A) could be more easily to be accepted by the public, which achieves the final object of elevating the rate of depleting the NOx pollutant in the air pollution.

To sum up, the present invention could achieve the above-mentioned objects and functions, so it is conforms to the application issue of patent pending, so we apply for this patent according to the patent law.

What is claimed is:

1. The Pt/Rh noble metal catalyst as a direct decomposition of NOx catalyst without the reducing agent, wherein the catalyst carrier is a mixture of Zeolite and Al₂O₃.

2. The deNOx catalyst as mentioned in claim 1, wherein zeolite is made up of ferrite and its SiO₂/AlO₂ ratio is equal to 55.

3. The deNOx catalyst as mentioned in claim 1, wherein zeolite is made up of MOR style and its SiO₂/AlO₂ ratio is equal to 90.

4. The deNOx catalyst as mentioned in claim 1, wherein zeolite is made up of BEA style and its SiO₂/AlO₂ ratio is equal to 75.

5. The deNOx catalyst as mentioned in claim 1, wherein zeolite is made up of FAU style and its SiO₂/AlO₂ ratio is equal to 60.

6. The deNOx catalyst as mentioned in claim 1, wherein zeolite is made up of MFI style and its SiO₂/AlO₂ ratio is equal to 80.

7. The deNOx catalyst as mentioned in claim 1, wherein said noble metal solution is Pd/Rh composition.
